(19) United States
(12) Patent Application Publication
(10) Pub. No.: US 2022/0186551 A1
(43) Pub. Date: Jun. 16, 2022

(54) METHOD AND DEVICE FOR ASSEMBLING INSULATING GLASS PANELS AS WELL AS INSULATING GLASS PANEL PRODUCED IN THIS WAY

(71) Applicant: Glaston Germany GmbH, Neuhausen-Hamberg (DE)

(72) Inventors: Peter Schuler, Tiefenbronn (DE); Klaus Puschmann, Bad Schoenborn (DE)

(73) Assignee: Glaston Germany GmbH, Neuhausen-Hamberg (DE)

(21) Appl. No.: 17/652,887

(22) Filed: Feb. 28, 2022

Related U.S. Application Data
(63) Continuation of application No. PCT/EP2020/073093, filed on Aug. 18, 2020.

(30) Foreign Application Priority Data
Sep. 4, 2019 (DE) 10 2019 123 700.9

(51) Int. Cl. E06B 3/673; E06B 3/663; E06B 3/667; E06B 3/66

(52) U.S. Cl. CPC E06B 3/67369; E06B 3/66328; E06B 3/6675; E06B 3/6604; E06B 3/67373; E06B 3/67386; E06B 3/6733

(57) ABSTRACT

A method and device for assembling an insulating glass panel includes: a TPS station for applying a paste-like TPS strand onto a standing glass sheet edge which includes a horizontal conveyor; a rotation station with a horizontal conveyor rotatable about a vertical axis of rotation; a pressing station for joining two glass sheets that have each been provided with a TPS strand to form the insulating glass panel including two horizontal conveyors running parallel to one another; and a controller for directing two glass sheets that are supplied to the rotation station one after another and each provided with a TPS strand into the pressing station by rotating one of the glass sheets and for joining same in said pressing station to form the insulating glass panel.

### CROSS REFERENCE TO RELATED APPLICATIONS

The continuation application claims priority to PCT/EP2020/073093 filed on Aug. 18, 2020 which has published as WO 2021/043568 A1 and also the German application number 10 2019 123 700.9 filed on Sep. 4, 2019 and published as DE 10 2019 123 700 A1, the entire contents of which are fully incorporated herein with these references.

### DESCRIPTION

### Field of the Invention

The invention is based on a method and a device for assembling an insulating glass panel having at least two glass sheets spaced apart by a TPS spacer, as well as such an insulating glass panel.

### Background of the Invention

Document DE 44 33 74 A1 describes such a method and such a device. The device contains a TPS station, which is configured for applying a paste-like TPS strand made of a thermoplastic material, which subsequently solidifies, onto a glass sheet. The term TPS for thermoplastic spacers in insulating glass panes is a registered trademark of the applicant. The TPS strand is applied by means of a nozzle which is moved along the edge of the glass sheet around the glass sheet, thereby placing the strand exiting the nozzle on the glass sheet in such a way that the beginning and end of the strand coincide.

Furthermore, document EP 2 802 727 B1 discloses a method and a device for assembling insulating glass panels from at least two glass sheets. The device contains a rotation station, which has two parallel horizontal conveyors. Both horizontal conveyors can be rotated around a vertical axis of rotation and are configured for conveying standing glass sheets through the rotation station and to rotate glass sheets standing thereon. A pressing station is arranged downstream of the rotation station, which also has two parallel horizontal conveyors. These two conveyors are configured for conveying standing glass sheets through the pressing station. The pressing station is configured for joining together two glass sheets to form the insulating glass panel. Upstream of the rotation station, a visual inspection and frame placement station is arranged, in which a frame-shaped spacer is placed on the second glass sheet.

It is also known per se to use a reactively cross-linking TPS material for the TPS strand. Such a system is described, for example, in US 2009/0291238 A1. The cured TPS material can serve as an integrated edge seal of the insulating glass panel, which simultaneously ensures all necessary functions, in particular a water vapour-tight and gas-tight sealing and bonding of the spacer. In addition, a desiccant may also be included. It is also known per se to use a primer as an adhesion promoter to ensure a rigid connection between the TPS strand and the surface of the respective glass sheet. This is described, for example, in EP 2 963 226 A1, in which a silane is applied to the edge of the glass sheet as a primer.

It may be an object of the invention to create an improved method and an improved device for assembling an insulating glass panel, as well as an improved insulating glass panel.

This object may be achieved by a device, a method, and by an insulated glass panel having the features of the respective independent claims.

### SUMMARY OF THE INVENTION

A device according to the invention for assembling an insulating glass panel containing at least two glass sheets, spaced apart by a TPS spacer, comprises: a TPS station, which is configured for applying a paste-like TPS strand, that subsequently solidifies, onto a standing glass sheet along the edge thereof, and which TPS station has a horizontal conveyor configured for conveying standing glass sheets through the TPS station; a rotation station arranged downstream of the TPS station, which rotation station has at least one horizontal conveyor that can be rotated about a vertical axis of rotation, which horizontal conveyor is configured for conveying standing glass sheets through the rotation station and for rotating the glass sheets standing thereon; a pressing station arranged downstream of the rotation station, which pressing station is configured for joining two glass sheets that have each been provided with a TPS strand to form the insulating glass panel, and which pressing station has two horizontal conveyors running parallel to one another that are each configured for conveying standing glass sheets; and a controller which is configured for directing two glass sheets that are supplied to the rotation station one after another and each provided with a TPS strand into the pressing station by rotating one of the glass sheets and for joining same in said pressing station to form the insulating glass panel.

A device according to the invention for assembling an insulating glass panel with at least two glass panels, which are spaced apart by a TPS spacer, contains a TPS station, a rotation station arranged downstream of the TPS station, a pressing station arranged downstream of the rotation station, and a controller, in particular a computer controller. The device may contain a primer station arranged upstream of the TPS station. The primer station is configured for applying a primer onto a standing glass panel along the edge thereof in a strip-like manner. The primer station has a horizontal conveyor which is configured for conveying standing glass sheets through the primer station. For applying the primer, the primer station may contain a nozzle that can be moved vertically along the edge of the glass sheet, in order to apply primer on the standing glass sheet in cooperation with the glass sheet moved horizontally by the horizontal conveyor. A “standing glass sheet” is understood to mean a glass sheet standing on one of its edges. The standing glass sheet may be inclined a few degrees from the vertical and may be supported on support means, such as a slightly inclined support wall or support rollers of the device, so that it does not accidentally fall over. In the case of the present invention, the glass sheets are always in a standing position, which means that all method steps, including the transport between the individual stations, are carried out in a standing position. The TPS station is configured for applying a paste-like TPS strand that subsequently solidifies onto a standing glass sheet along the edge thereof. A suitable material for the TPS strand is a thermoplastic material, which solidifies simply by cooling, or a reactively cross-linking material in which a chemical reaction causes solidification. The TPS station has a horizontal conveyor, which is configured for conveying standing glass sheets through the corresponding station. For applying the TPS strand, the TPS station may contain a nozzle that can be moved vertically along the edge of the glass sheet, in order to place the TPS strand that exits the nozzle on the standing glass sheet in a frame-like manner in cooperation with the glass sheet moved horizontally by the horizontal conveyor. In a manner known per se, the rotation station contains at least one horizontal conveyor, which is configured for conveying standing glass sheets through the rotation station. The horizontal conveyor of the rotation station is configured for rotating glass sheets standing thereon and can be rotated about a vertical axis of rotation for this purpose. The pressing station contains two parallel-running horizontal conveyors, each of which is configured for conveying standing glass sheets. One of these is configured for conveying the insulating glass panel out of the pressing station. This can also be configured for conveying glass sheets through the pressing station. The pressing station is configured for joining two glass sheets that have each been provided with a TPS strand to form the insulating glass panel. If necessary, both glass sheets may be provided with a primer strip and a TPS strand applied thereon. The pressing station can be designed in the manner known from EP 2 802 727 B1. The stations' horizontal conveyors can be arranged one after the other in a straight line, so that standing glass sheets arranged individually one after the other can be conveyed without any change of direction through the assembly device forming a production line. All the device's support means that support the standing glass sheet can be arranged in a plane for this purpose. The horizontal conveyor of the rotation station is offset with respect to the vertical axis of rotation by half the distance between the two parallel horizontal conveyors of the pressing station, so that the horizontal conveyor of the rotation station, which is aligned with one horizontal conveyor of the pressing station, aligns with the second horizontal conveyor of the pressing station after a rotation of 180°. The controller is configured for directing two glass sheets that have each been provided with a TPS strand and are supplied to the rotation station one after another into the pressing station by rotating one of the glass sheets and for joining same in said pressing station to form the insulating glass panel.

According to the invention, a first method for assembling an insulating glass panel has the following steps: a first glass sheet standing on one of its edges is conveyed into a TPS station; in the TPS station, a paste-like TPS strand that subsequently solidifies is applied onto the standing first glass sheet along the edge thereof; after applying the TPS strand, the standing first glass sheet is conveyed from the TPS station into a rotation station; a second glass sheet standing on one of its edges is conveyed into the TPS station; in the TPS station, a paste-like TPS strand that subsequently solidifies is applied onto the standing second glass sheet along the edge thereof; in the rotation station, the standing first glass sheet is rotated about a vertical axis of rotation; after rotation, the standing first glass sheet is conveyed out of the rotation station into a pressing station; after applying the TPS strand, the standing second glass sheet is conveyed out of the TPS station via the rotation station into the pressing station, so that both glass sheets stand opposite each other at a distance and their TPS strands are facing each other; in the pressing station, the two glass sheets are joined together to form the insulating glass panel by reducing the distance between the two glass sheets until the two TPS strands rest against each other and the two glass sheets have a predefined distance from each other; after the joining operation, the insulating glass panel is conveyed out of the pressing station.

In the first method according to the invention, a first standing glass sheet is conveyed into the TPS station. If a primer station is provided, the first standing glass sheet is first conveyed into it and a primer can be applied onto this glass sheet in a strip-like manner along the edge thereof. After the primer strip has been applied, the first glass sheet is conveyed from the primer station into the TPS station, using the horizontal conveyors of the primer station and the TPS station. In the TPS station, a paste-like TPS strand that subsequently solidifies is applied to the first glass sheet. Then, the first glass sheet is conveyed out of the TPS station into the rotation station. This is carried out with the horizontal conveyor of the TPS station and the horizontal conveyor of the rotation station, the latter being arranged in alignment with the former. A second glass sheet can then be conveyed into the primer station, sequentially or overlapping with the conveying of the first glass sheet out of the primer station. In the primer station, a primer strip can be applied onto the second glass sheet. The first glass sheet is rotated in the rotation station about a vertical axis of rotation. After rotation, the first glass sheet is conveyed out of the rotation station into the pressing station. The first glass sheet can be conveyed out of the rotation station and into the pressing station without stopping. However, the first glass sheet can also be stopped for a certain length of time in a buffer station arranged, if necessary, between the rotation station and the pressing station. After applying the primer strip onto the second glass sheet, it is conveyed out of the primer station into the TPS station. In the TPS station, a paste-like TPS strand that subsequently solidifies is applied onto the second glass sheet. The second glass sheet is conveyed out of the TPS station via the rotation station into the pressing station without rotation, so that both glass sheets stand opposite each other at a distance and their TPS strands or primer strips are facing each other. The second glass sheet can be conveyed through the rotation station without stopping, or be stopped on the horizontal conveyor in the rotation station for a certain period of time. The two glass sheets thus stand opposite each other in pairs in the pressing station on the two horizontal conveyors of the pressing station. The two glass sheets can stand in a V-shape with respect to each other and can be slightly tilted in opposite directions with respect to the vertical. In the pressing station, the space between the two glass sheets can be filled in a manner known per se with a gas other than air, to improve the insulation effect of the insulating glass panel. Then the two glass sheets are joined together in the pressing station to form the insulating glass panel by reducing the distance between the two glass sheets until the TPS strands form a spacer between the two glass sheets and hold the two glass sheets at a predefined distance from each other. The spacer is formed by two TPS strands, and the distance between the two glass sheets is reduced until the two TPS strands lie on top of each other and the two glass sheets have a predefined distance from each other. After the joining operation, the insulating glass panel is conveyed out of the pressing station.

Also according to the invention, an alternative method for assembling an insulating glass panel has the following steps: a first glass sheet standing on one of its edges is conveyed into a TPS station; in the TPS station, a paste-like TPS strand that subsequently solidifies is applied onto the standing first glass sheet along the edge thereof; after applying the TPS strand, the standing first glass sheet is conveyed from the TPS station via a rotation station into a pressing station; a second glass sheet standing on one of its edges is conveyed into the TPS station; in the TPS station, a paste-like TPS strand that subsequently solidifies is applied onto the standing second glass sheet along the edge thereof; after applying the TPS strand, the standing second glass sheet is conveyed from the TPS station into the rotation station; in the rotation station, the standing second glass sheet is rotated about a vertical axis of rotation; after rotation, the standing second glass sheet is conveyed out of the rotation station into the pressing station, so that both glass sheets stand opposite each other at a distance and their TPS strands are facing each other; in the pressing station, the two glass sheets are joined together to form the insulating glass panel by reducing the distance between the two glass sheets until the two TPS strands rest against each other and the two glass sheets have a predefined distance from each other; after the joining operation, the insulating glass panel is conveyed out of the pressing station.

In the alternative method according to the invention, a TPS strand is applied to each of the glass sheets in the same way as for the first method described above. In an alternative to the first method described above, the first glass sheet is conveyed out of the TPS station via the rotation station into the pressing station without rotation. The second glass sheet is then conveyed out of the TPS station into the rotation station and rotated therein about a vertical axis of rotation. After rotation, the second glass sheet is conveyed out of the rotation station into the pressing station, so that both glass sheets stand opposite each other at a distance and their TPS strands or primer strips are facing each other. Then the two glass sheets are joined together in the pressing station in the above-described way to form the insulating glass panel.

An insulating glass panel according to the invention contains at least two glass sheets and an intermediate spacer, which, due to its height, holds the two glass sheets at a predefined distance from each other, characterized in that the spacer is formed by placing two paste-like TPS strands, which subsequently solidify, on top of each other, the combined height of both resulting in the height of the spacer.

The insulating glass panel according to the invention comprises at least two glass sheets and a spacer arranged between them. The spacer holds the two glass sheets in a predetermined distance due to its height. The spacer is formed by placing two TPS strands together, the combined height of which results in the height of the spacer, each of the strands can be rigidly connected to the respective glass sheet by means of a primer strip applied onto its surface. The insulating glass panel may also contain three glass sheets which are held by two spacers.

The invention may have (but which are not necessary) substantial advantages:

By using a suitable primer, the adhesion between the material of the TPS strand and the glass surface can be considerably improved and the sealing properties, in particular with regard to an undesirable gas exchange and unwanted penetration of water vapour, can be greatly improved.

The otherwise usual step of applying a sealing compound based on a polysulfide (e.g. Thiokol), polyurethane or silicone, after the transport of the insulating glass panel out of the pressing station, as described for example in DE 10 2007 051 610 A1, can be omitted when using a reactively cross-linking TPS material. This means that the assembly device no longer requires a sealing station, which simplifies its construction and greatly simplifies the production of the insulating glass panels.

Due to the combination of a primer station and a TPS station with a rotation station and a pressing station having two parallel horizontal conveyors, primer can be applied directly onto the glass sheet, namely onto the first glass sheet as well as onto the second glass sheet before applying the TPS strand. The primer strip can therefore be applied directly to the surface of the glass sheet. This is a significant advantage, as it improves the effectiveness of the primer. At the same time, contact between the applied primer and support means for supporting the standing glass sheet is prevented since the primer is always applied to the surface of the glass sheet facing away from the support means. The TPS strand is then applied to the primer strip. The width of the primer strip can correspond to the width of the TPS strand or be slightly wider.

The contamination of the device during operation is greatly reduced.

When assembling an insulating glass panel in the device according to the invention, the surfaces of the glass sheets later located inside the insulating glass panel do not come into contact with support means for supporting the standing glass sheets. This is particularly important if these surfaces have sensitive coatings.

A particularly efficient and time-saving production of insulating glass panes can be achieved.

If, according to the invention, the spacer is formed by placing two TPS strands together, the combined height of which results in the height of the spacer, then it is particularly easily possible to produce insulating glass panels, in which the glass sheets have a relatively large distance to one another. When applying a paste-like and subsequently solidifying TPS strand to a standing glass sheet along the edge thereof, it may happen that the still soft TPS strand sags and/or tilts due to the action of gravity on it, if its height measured perpendicular to the glass sheet is relatively large. The height of spacers formed by a TPS strand when applied to standing glass sheets has therefore up to now been limited. According to the invention, the total height required for the spacer can be divided over two TPS strands. This prevents unwanted sagging or tilting of the respective TPS strand on the standing glass sheet. This embodiment of the invention enables insulating glass panels and TPS spacers of very good quality, even if the distance between the two glass sheets is more than 15 mm, in particular 16 mm to 32 mm. In addition, this embodiment of the invention is very well suited for insulating glass panels in which a glazing bar frame is arranged between the two glass sheets. The glazing bar frame can be held by both TPS strands of the spacer in such a way that it is spaced apart from both glass sheets and thus does not directly touch either of the glass sheets. This is particularly advantageous if a coating is present on the inside of the glass sheet.

Insulating glass panels with TPS spacers and an inserted glazing bar frame are known from DE 295 14 622 U1. In the known method, a TPS strand was first applied to one of the glass sheets at the height required for the spacer. A glazing bar frame was then inserted into the frame-shaped spacer, wherein the glazing bar frame was fastened by means of additional end pieces, which were glued to one of the glass sheets. The insertion of the glazing bar frame into the frame-shaped TPS spacer is prone to error, as the material of the TPS strand is still soft and deformable at this time. In addition, DE 10 2004 043 581 A1 discloses glazing bars for installation in an insulating glass panel, in which glazing bar end pieces are provided which have means for anchoring to the spacer. However, the TPS spacer can still very easily become deformed or damaged when inserting a glazing bar or a glazing bar frame.

In an embodiment of the invention, a glazing bar station can be arranged between the TPS station and the rotation station. The glazing bar station is configured for placing a glazing bar frame on a TPS strand running along the edge of a glass sheet. The glazing bar station has a horizontal conveyor which is configured for conveying standing glass sheets through the glazing bar station. Before the two glass sheets are joined together, a glazing bar frame can be placed on the TPS strand of one of the glass sheets, in particular on the second glass sheet. The glazing bar frame can be placed in particular on the glass sheet to be conveyed in a straight line through the rotation station. At the ends of the plurality of glazing bars of a glazing bar frame, retaining elements can be arranged with which the glazing bar frame can be placed on a surface of the still soft material of the TPS strand, said surface being parallel to the glass sheet. The glazing bar frame is then pressed in slightly. Pressing in by a small amount is sufficient, as the parts of the retaining elements that still protrude beyond the surface of the TPS strand, during joining to the other glass sheet, are also slightly pressed into a surface of the TPS strand present on the other glass sheet, said surface being parallel to the glass sheet. The retaining elements of the glazing bar frame are then each embedded half way into one of the two TPS strands. If both TPS strands have the same height, the glazing bar frame is exactly centred between the glass sheets. Contact of the glazing bar frame with an inner side of the glass sheets can be reliably prevented. The glazing bar frame can be positioned very precisely, without the risk that the still soft TPS strand will become deformed or damaged in an undesirable way. This can improve the quality of the insulating glass panels produced and can reduce the scrap rate.

In a further embodiment of the invention, it may be provided that the rotation station has two horizontal conveyors parallel to each other. This design enables further cycle time optimization in the production of the insulating glass panel. The first glass sheet can be conveyed on the first horizontal conveyor of the rotation station. The rotation station can then be rotated through 180°. The second glass sheet can then be conveyed to the second horizontal conveyor of the rotation station. At this point the two glass sheets already stand opposite each other at a distance in the rotation station, with their TPS strands or primer strips facing each other. The rotation station thus acts as a temporary store for two glass sheets. The rotation station can already be filled if the pressing station is still occupied by the joining of another insulating glass panel. Between the rotation station and the pressing station, a buffer station may also be arranged, which has two horizontal conveyors and is configured for the temporary storage of two glass sheets standing on the horizontal conveyors in a way of facing each other in a V-shape. The joining of the two glass sheets in the pressing station often takes longer than the processing times in the TPS station and the rotation station, in particular when gas filling is also carried out in the pressing station. If the pressing station is then free, the two glass sheets already available in the rotation station or the buffer station can be conveyed out of the rotation station or the buffer station into the pressing station simultaneously and parallel to each other. The device for assembling can thus be used very efficiently.

### BRIEF DESCRIPTION OF THE DRAWINGS

Further advantages and features of the invention can be found in the following description of some exemplary embodiments in connection with the drawings. Shown are:

FIG. 1 is a schematic structure of a device according to the invention for assembling an insulating glass panel;

FIG. 2 is a schematic oblique view of an edge region of a first glass sheet;

FIG. 3 is a side view similar to FIG. 2;

FIG. 4 is a schematic side view of an edge region of a fully assembled insulating glass panel according to the present invention;

FIG. 5 is a schematic side view of an edge region of a variant of an insulating glass panel according to the invention during insertion of a glazing bar frame;

FIG. 6 is a schematic side view of the edge region of the assembled insulating glass panel of FIG. 5; and

FIGS. 7 and 8 are views of a variant according to the invention similar to FIGS. 5 and 6.

### DETAILED DESCRIPTION OF THE EMBODIMENTS

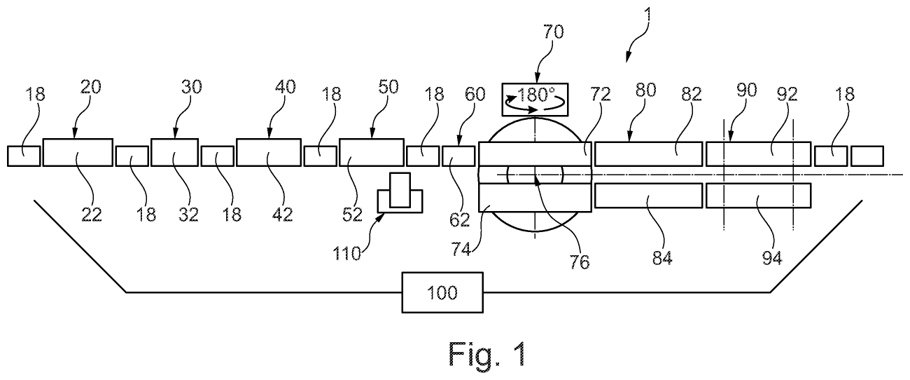

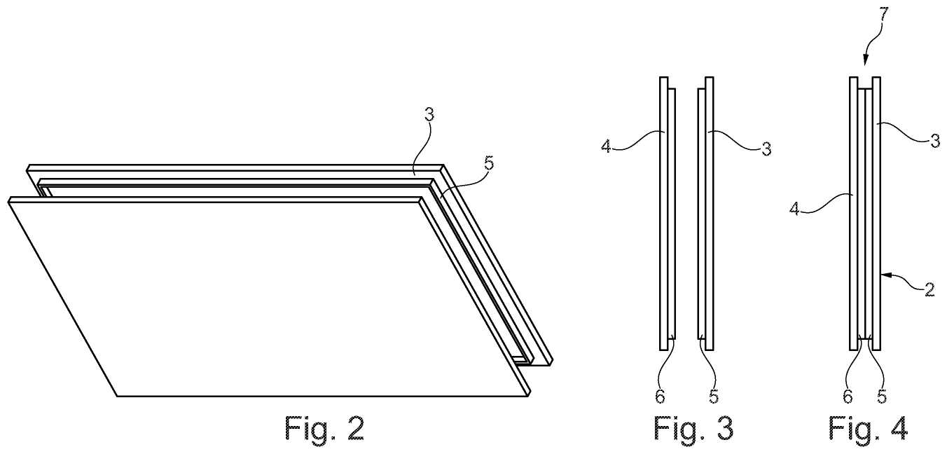

FIG. 1 schematically shows a device 1, which is often also designated as a production line, for assembling an insulating glass panel 2, which is shown in FIGS. 2 to 8. The insulating glass panel 2 contains two glass sheets 3 and 4. On the first glass sheet 3 in the embodiment of FIGS. 7 and 8, a primer is applied in the form of a primer strip 13 along the edge of the glass sheet 3. In the same way, a primer 14 is applied in a strip-like manner along the edge of the glass sheet 4. Then, a paste-like TPS strand 5, 6 that subsequently solidifies is applied along the edge thereof. When the glass sheets 3 and 4 are joined together, the TPS strand 5 is placed on the primer strip 13 and forms together with the TPS strand 6 a spacer 7 between the two glass sheets 3 and 4, which, due to its height, holds the two glass sheets 3 and 4 at a predefined distance from each other. The height of the TPS strands 5, 6 essentially results in the height of the spacer 7, as the primer strips 13 and 14 are not shown to scale in FIGS. 7 and 8 for clarity. A reactively cross-linking TPS material is used, which together with the primer 13, 14 ensures a rigid connection to the surfaces of the glass sheets 3 and 4, so that no additional edge sealing is required.

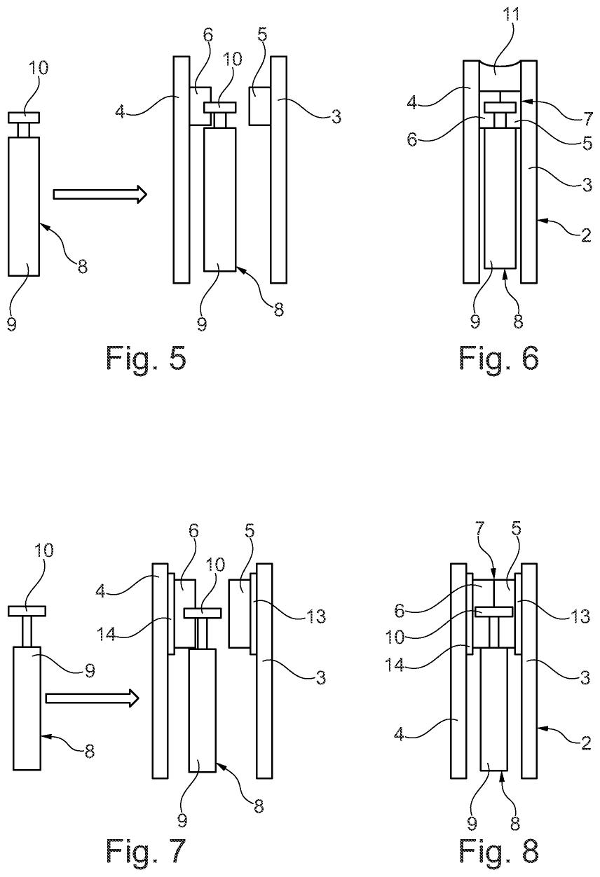

In the variant of an insulating glass panel 2 according to the invention, see FIGS. 5 to 8, a glazing bar frame 8 is placed on the TPS strand 6 of the second glass sheet 4 before the two glass sheets 3 and 4 are joined together. The glazing bar frame 8 contains at least one glazing bar 9 which has a retaining element 10 at both ends, with only one end of the glazing bar 9 being shown. The retaining element 10 is T-shaped as viewed from the side and, for example, circular as viewed from above. When putting the glazing bar frame 8 in place, the retaining element 10 is pressed into the surface of the still soft material of the TPS strand 6. In this variant, a paste-like TPS strand 5 that subsequently solidifies is also applied onto the first glass sheet 3, or onto the primer strip 13 of the first glass sheet 3 respectively, along its edge. The height of the TPS strands 5 and 6 is slightly higher during application than in the finished insulating glass panel 2, since the TPS strands 5 and 6 are slightly compressed when the glass sheets 3 and 4 are joined together, which slightly reduces their height. In the finished insulating glass panel 2, each of the TPS strands 5 and 6 can be half the height of the spacer 7. For example, for an insulating glass panel 2 with an inter-sheet gap of 16 mm, the two TPS strands 5 and 6 can be applied at a height of 8.7 mm. When applying the TPS strands 5 and 6, any sagging or tilting in relation to the standing glass sheet 3, 4 is prevented due to their reduced height. Then, during the joining process, the retaining element 10 is also pressed into the still soft material of the TPS strand 5 of the first glass sheet 3. The glazing bar frame 8 is then seated exactly centrally between the glass sheets 3 and 4 in the finished insulating glass panel 2, see FIGS. 6 and 8, and is held by the two TPS strands 5 and 6. The glazing bar frame 8 is therefore spaced apart from both glass sheets 3 and 4 and does not touch either of them. This can prevent the glazing bar frame 8 from damaging any coating that might be applied to an inner side of the glass sheet 3, 4.

The device 1 according to the invention contains a plurality of stations for carrying out the various steps during the assembly of the insulating glass panel 2, wherein additional horizontal conveyors 18 may be arranged between the individual stations as required. The device 1 contains a washing station 20, a visual inspection station 30, a primer station 40, a TPS station 50, a glazing bar station 60, a rotation station 70, a buffer station 80, and a pressing station 90. In particular, the glazing bar station 60 can be omitted if necessary. The washing station 20 contains a horizontal conveyor 22, the visual inspection station 30 contains a horizontal conveyor 32, the primer station 40 contains a horizontal conveyor 42, the TPS station 50 contains a horizontal conveyor 52, and the glazing bar station 60 contains a horizontal conveyor 62. The horizontal conveyors 18, 22, 32, 42, 52 and 62 are arranged in a line and are configured for conveying standing glass sheets through the individual stations. They can be driven separately for this purpose. The device 1 contains, in a known manner and not illustrated, support means to support glass sheets standing on its horizontal conveyors at a slight incline to the vertical. The rotation station 70 has two horizontal conveyors 72 and 74, which can each be rotated about a vertical axis of rotation 76. The buffer station 80 also has two parallel horizontal conveyors 82 and 84. The pressing station 90 is configured in a manner known per se for joining the two glass sheets 3, 4 to form the insulating glass panel 2 and has two horizontal conveyors 92 and 94 running in parallel. The device 1 also contains a controller 100, which is configured for controlling the components of the device 1 in the manner described in more detail below. The controller 100 is configured in particular for directing two glass sheets 3, 4 that are supplied to the rotation station 70 one after another and each provided with a TPS strand 5, 6 into the pressing station 90 by rotating one of the glass sheets 3 or 4 and for joining same in said pressing station to form the insulating glass panel 2. The device 1 may contain a scanner 110 for monitoring the quality of the applied TPS strands, which can be arranged, for example, between the TPS station 50 and the glazing bar station 60. The functioning and structure of each of the individual stations is already known, in particular from the prior art mentioned above, so that a description of the details is not necessary.

The two horizontal conveyors 72 and 74 of the rotation station 70 are arranged at the same distance from each other as the horizontal conveyors 92 and 94 of the pressing station 90 and the horizontal conveyors 82 and 84 of the buffer station 80. The axis of rotation 76 is located centrally between the two horizontal conveyors 72 and 74, so that after a rotation through 180°, the horizontal conveyor 72 is aligned with the horizontal conveyor 94 and the horizontal conveyor 74 is aligned with the horizontal conveyor 92. This ensures a smooth transport of the glass sheets 3, 4 from the rotation station 70 into the pressing station 90.

In the method for assembling the insulating glass panel 2, the device 1 is controlled by the controller 100 in such a way that the first glass sheet 3, which stands with one of its edges on the horizontal conveyor 18, is conveyed into the washing station 20 by means of the horizontal conveyors 18, 22. In the washing station 20, the glass sheet 3 is cleaned, especially on its surface which will later form the inner side of the insulating glass panel 2. Subsequently, the glass sheet 3 is conveyed into the visual inspection station 30 by the horizontal conveyors 22, 18 and 32. The glass sheet 3 can be inspected here to detect any faults. Subsequently, the insulating glass panel 3 is conveyed into the primer station 40 by the horizontal conveyors 32, 18 and 42. In the primer station 40, if applicable, a primer 13 is applied in a strip-like manner along the edge of the glass sheet 3 onto the surface thereof, which later forms the inner side of the insulating glass panel 2. Thereafter, the glass sheet 3 is conveyed to the TPS station 50 by means of the horizontal conveyors 42, 18 and 52. Here, the paste-like TPS material that subsequently solidifies is applied onto the glass sheet 3 as a strand 5. Subsequently, the glass sheet 3 is conveyed into the glazing bar station 60 by the horizontal conveyors 52, 18 and 62. When the glass sheet 3 is conveyed out of the TPS station 50, it can be scanned by the scanner 110 and inspected for faults. If a fault is detected, the insulating glass panel 2 containing the glass sheet 3 can be screened out later. The glass sheet 3 is conveyed through the glazing bar station 60 by the horizontal conveyor 62 without a glazing bar frame 8 being placed thereon. The glass sheet 3 is conveyed into the rotation station 70 by the horizontal conveyor 72. Subsequently, the horizontal conveyors 72 and 74 of the rotation station and the glass sheet 3, which is standing on the horizontal conveyor 72, are rotated through 180°. The horizontal conveyor 72 is then aligned with the horizontal conveyor 84 and the horizontal conveyor 74 is aligned with the horizontal conveyors 62 and 82. The glass sheet 3 initially remains on the horizontal conveyor 72, but can also be conveyed onward directly into the buffer station 80 or the pressing station 90.

Temporally overlapping with the preceding processing of the first glass sheet 3, the second glass sheet 4 is fed to the washing station 20 by means of the horizontal conveyors 18 and 22 as soon as the first glass sheet 3 has left the washing station 20. To achieve the shortest possible cycle time, the second glass sheet 4 follows as closely as possible behind the first glass sheet 3. A third glass sheet can follow behind the second glass sheet 4 if the insulating glass panel is designed to consist of three glass sheets. Otherwise, glass sheets for further insulating glass panels will follow. The second glass sheet 4 is conveyed in the manner described above to the glazing bar station 60 and processed accordingly in the stations 20, 30, 40 and 50. In particular, the TPS strand 6 is applied in the TPS station 50. If the insulating glass panel 2 is to have a glazing bar frame 8, this is placed on the second glass sheet 4 standing in the glazing bar station 60 and pressed a short way into the surface of the still soft material of the TPS strand 6, see FIGS. 5 and 7. The second glass sheet 4 is then conveyed into the rotation station 70 with the horizontal conveyors 62 and 74, so that the two glass sheets 3 and 4 stand opposite each other in a V-shape at a distance and their TPS strands 5, 6 or primer strips 13 and 14 are facing each other. They are then conveyed together via the buffer station 80 into the pressing station 90. In case the pressing station 90 is not yet free, because the joining of another insulating glass panel has not yet been completed, the horizontal conveyors 82, 84 can be stopped and the two glass sheets 3 and 4 can be temporarily stored in the buffer station 80 so that the rotation station 70 is now free again to receive glass sheets for a following insulating glass panel.

Since the rotation station 70 has two horizontal conveyors 72 and 74, the rotation station 70 does not need to be turned back after the pair of glass sheets 3, 4 has left the rotation station 70. Instead, the first glass sheet of a following insulating glass panel can be taken over by the horizontal conveyor 74, which is aligned with the horizontal conveyor 62, and then turned back. Only then is the rotation station again located in the position shown in FIG. 1. When the glass sheet pair 3, 4 is conveyed into the pressing station 90, the first glass sheet 3 is conveyed by the horizontal conveyors 84 and 94 and the second glass sheet 4 (possibly with a glazing bar frame 8) is conveyed on the horizontal conveyors 82 and 92. If the two glass sheets 3, 4 in the pressing station 90 stand opposite each other at a distance, with their TPS strands 5, 6 or primer strips 13, 14 facing each other, their distance from each other is reduced in the known manner until the two glass sheets 3, 4 are held by the spacer 7 at a predefined distance from each other. Before the edge region of the insulating glass panel 2 is completely closed or the two TPS strands 5, 6 are completely touching each other, the space between the two glass sheets 3, 4 can be filled with a gas other than air in a manner known per se. The glass panels 3, 4 are then pressed together to a predefined distance, so that the still soft material of the two TPS strands 5, 6 connects, compare FIGS. 5 to 8. In doing so, the retaining elements 10 of a possibly previously put in place glazing bar frame 8 are embedded in the TPS strands 5 and 6, compare FIGS. 6 and 8, so that the glazing bar frame 8 is positioned and held precisely and securely in the insulating glass panel 2. After the joining operation, the insulating glass panel 2 is conveyed on the horizontal conveyor 92 out of the pressing station 90.

The invention is also very suitable for the production of a triple insulating glass panel. In such a case, the device 1 shown in FIG. 1 is supplemented, in a manner not illustrated, by additional stations after the pressing station 90, namely a primer station, a rotation station, a buffer station and a pressing station. These are configured in the same way as the stations 40, 70, 80 and 90. With the additional primer station, a primer can be applied on the outer side of the glass sheet 3 of the prefabricated double insulating glass panel 2, see FIGS. 4, 6 and 8, in a strip-like manner along its edge. The double insulating glass panel 2, which is provided with a primer strip, is conveyed to the additional pressing station via the additional rotation station without rotation. The third glass panel required for the triple insulating glass panel is prepared in stations 20, 30, 40 and 50 in the same way as the second glass panel 4, see FIG. 3, and conveyed through stations 60, 70, 80 and 90 without further processing. This is done before or after the joining of the double insulating glass panel 2, in particular before it. In the additional rotation station, which is arranged downstream of the pressing station 90, the prepared third glass sheet is turned and conveyed onward so that the TPS strand located on the third glass sheet and the primer strip on the double insulating glass panel are opposite each other. They are then joined together in the pressing station. If another TPS strand is also to be applied to the outer side of the prefabricated double insulating glass panel 2, compare FIGS. 4, 6 and 8, which together with the TPS strand applied to the third glass sheet then forms a spacer like that of FIG. 6 or 8, composed of two TPS strands, for the third glass sheet, the device 1, in particular before the additional rotation station, can also have an additional TPS station.

### LIST OF REFERENCE SIGNS

1 device

2 insulating glass panel

3 glass sheet

4 glass sheet

5 TPS strand

6 TPS strand

7 spacer

8 glazing bar frame

9 glazing bar

10 retaining element

11 sealing compound

13 primer

14 primer

18 horizontal conveyor

20 washing station

22 horizontal conveyor

30 visual inspection station

32 horizontal conveyor

40 primer station

42 horizontal conveyor

50 TPS station

52 horizontal conveyor

60 glazing bar station

62 horizontal conveyor

70 rotation station

72 horizontal conveyor

74 horizontal conveyor

76 axis of rotation

80 buffer station

82 horizontal conveyor

84 horizontal conveyor

90 pressing station

92 horizontal conveyor

94 horizontal conveyor

100 controller

110 scanner

What is claimed is:

1. A device for assembling an insulating glass panel containing at least two glass sheets, spaced apart by a TPS spacer, comprising:
a TPS station, which is configured for applying a paste-like TPS strand, that subsequently solidifies, onto a standing glass sheet along the edge thereof, and which TPS station has a horizontal conveyor configured for conveying standing glass sheets through the TPS station;
a rotation station arranged downstream of the TPS station, which rotation station has at least one horizontal conveyor that can be rotated about a vertical axis of rotation, which horizontal conveyor is configured for conveying standing glass sheets through the rotation station and for rotating the glass sheets standing thereon;
a pressing station arranged downstream of the rotation station, which pressing station is configured for joining two glass sheets that have each been provided with a TPS strand to form the insulating glass panel, and which pressing station has two horizontal conveyors running parallel to one another that are each configured for conveying standing glass sheets; and
a controller which is configured for directing two glass sheets that are supplied to the rotation station (70) one after another and each provided with a TPS strand into the pressing station by rotating one of the glass sheets and for joining same in said pressing station to form the insulating glass panel.

2. The device according to claim 1, wherein the rotation station has two horizontal conveyors which are parallel to each other.

3. The device according to claim 1, including a glazing bar station, which is configured for placing a glazing bar frame onto a TPS strand running along the edge of one of the glass sheets, and which has a horizontal conveyor configured for conveying standing glass sheets through the glazing bar station.

4. The device according to claim 3, wherein the glazing bar station is arranged between the TPS station and the rotation station.

5. The device according to claim 1, including a primer station arranged upstream of the TPS station and configured for applying a primer in a strip-like manner along the edge of a standing glass sheet, and which primer station has a horizontal conveyor which is configured for conveying standing glass sheets through the primer station.

6. A method for assembling an insulating glass panel comprising the following steps:
conveying a first glass sheet standing on one of its edges into a TPS station;
in the TPS station, applying a paste-like TPS strand that subsequently solidifies onto the standing first glass sheet along the edge thereof;
after applying the TPS strand, conveying the standing first glass sheet from the TPS station into a rotation station;
conveying a second glass sheet standing on one of its edges into the TPS station;
in the TPS station, applying a paste-like TPS strand that subsequently solidifies onto the standing second glass sheet along the edge thereof;
in the rotation station, rotating the standing first glass sheet about a vertical axis of rotation;
after rotation, conveying the standing first glass sheet out of the rotation station into a pressing station;
after applying the TPS strand, conveying the standing second glass sheet out of the TPS station via the rotation station into the pressing station, so that both glass sheets stand opposite each other at a distance and their TPS strands are facing each other;
in the pressing station, joining the two glass sheets together to form the insulating glass panel by reducing the distance between the two glass sheets until the two TPS strands rest against each other and the two glass sheets have a predefined distance from each other;
after the joining operation, conveying the insulating glass panel out of the pressing station.

7. The method according to claim 6, wherein the standing first glass sheet is conveyed into the pressing station simultaneously with the second glass sheet, in particular out of the rotation station or a buffer station.

8. The method according to claim 6, wherein, before the two glass sheets are joined, a glazing bar frame is placed onto the TPS strand of one of the glass sheets and is pressed into the surface of the still soft material of the TPS strand.

9. The method according to claim 6, wherein, before the TPS strand is applied, a primer is applied in a strip-like manner along the edge of each glass sheet.

10. A method for assembling an insulating glass panel comprising the following steps:
conveying a first glass sheet standing on one of its edges into a TPS station;
in the TPS station, applying a paste-like TPS strand that subsequently solidifies onto the standing first glass sheet along the edge thereof;
after applying the TPS strand, conveying the standing first glass sheet from the TPS station via a rotation station into a pressing station;
conveying a second glass sheet standing on one of its edges into the TPS station;
in the TPS station, applying a paste-like TPS strand that subsequently solidifies onto the standing second glass sheet along the edge thereof;
after applying the TPS strand, conveying the standing second glass sheet from the TPS station into the rotation station;
in the rotation station, rotating the standing second glass sheet about a vertical axis of rotation;
after rotation, conveying the standing second glass sheet out of the rotation station into the pressing station, so that both glass sheets stand opposite each other at a distance and their TPS strands are facing each other;
in the pressing station, joining the two glass sheets together to form the insulating glass panel by reducing the distance between the two glass sheets until the two TPS strands rest against each other and the two glass sheets have a predefined distance from each other;
after the joining operation, conveying the insulating glass panel out of the pressing station.

11. An insulating glass panel comprising:
at least two glass sheets and an intermediate spacer, which, due to its height, holds the two glass sheets at a predefined distance from each other;
wherein the intermediate spacer is formed by placing two paste-like TPS strands, which subsequently solidify, on top of each other, the combined height of both resulting in the height of the intermediate spacer.

12. The insulating glass panel according to claim 11, wherein a glazing bar frame is arranged between the two glass sheets, which is held at a distance from both glass sheets by the two TPS strands of the intermediate spacer.
